(19) United States
(12) Patent Application Publication
(10) Pub. No.: US 2023/0069605 A1
(43) Pub. Date: Mar. 2, 2023

(54) Controlling a Motor Vehicle Using a Vehicle-External Mobile Terminal

(71) Applicant: Bayerische Motoren Werke Aktiengesellschaft, Muenchen (DE)

(72) Inventors: Jan-Hendrik HARTMANN, Muenchen (DE); Frank HERGEMOELLER, Markt Schwaben (DE)

(21) Appl. No.: 17/796,926

(22) PCT Filed: Feb. 18, 2021
(86) PCT No.: PCT/EP2021/054028

§ 371 Date: Aug. 2, 2022

(30) Foreign Application Priority Data
Mar. 3, 2020 (DE) 10 2020 105 627.3

(51) Int. Cl. B60R 25/24; H04W 4/48; H04W 4/02; B60R 25/01; B60R 25/20

(52) U.S. Cl. CPC B60R 25/245; H04W 4/48; H04W 4/023; B60R 25/01; B60R 25/209

(57) ABSTRACT

A motor vehicle is controlled using a vehicle-external mobile terminal. A communication connection is established using a first transmission/reception device of the motor vehicle and second transmission/reception device of the mobile terminal. A distance and/or relative position of the mobile terminal in relation to the motor vehicle is ascertained by evaluating a radio signal transmitted via the communication connection. Clearance data is generated using a control circuit of the motor vehicle or of the mobile terminal based on the ascertained distance and/or the ascertained relative position. The clearance data indicates that a predetermined control command can be transmitted from the mobile terminal to the motor vehicle and/or is accepted from the mobile terminal by the motor vehicle. The predetermined control command is transmitted using the communication connection when the clearance data are available in the mobile terminal and a predetermined trigger condition for the respective control command is satisfied.

The present subject matter relates to a method for controlling a motor vehicle by means of a vehicle-external mobile terminal. Furthermore, the present subject matter also relates to a system having the motor vehicle and the mobile terminal. Finally, the present subject matter also relates to a motor vehicle and to a mobile terminal for such a system.

With the introduction of the Internet of Things, it has become possible to network electronic devices to one another and thus to allow an exchange of information between the devices. For example, it is thus possible for a mobile terminal, that is to say for example a smartphone or a tablet PC, to be coupled to a motor vehicle for the purpose of exchanging information or for the purpose of data transmission.

In this regard, for example WO 2019/027245 A1 discloses a communication method for allowing communication between a 5G communication system, such as for example the mobile terminal, and an IOT-based technology, such as for example a smart home or what is known as a smart car (smart motor vehicle).

A similar communication method is also known from US 2018/0262868 A1. This describes a system for providing location services for a mobile terminal in a mobile radio network, such as for example a radio access network (RAN). The mobile radio network may be in particular a 5G network.

The two aforementioned communication methods may be used for example to locate passers-by or drivers of other motor vehicles in road traffic on the basis of their mobile terminal, for example. This allows collisions to be avoided in road traffic, for example.

To now ensure that a smartphone is also connected to the correct motor vehicle for the purpose of data transmission, for example US 2017/0118178 A1 discloses a smartphone having an NFC tag and an NFC antenna (NFC: near field communication). The NFC tag comprises identification information relating to the smartphone that may be read by means of the NFC antenna and then transmitted to the motor vehicle by means of a signal transmission unit, for example by means of mobile radio, Bluetooth or WLAN (wireless local area network). The NFC tag may preferably also comprise a low-frequency radio interface in order to locate the smartphone with the NFC tag. This makes it possible for example to establish whether the NFC tag or the smartphone is inside the motor vehicle or outside the motor vehicle, it is possible to determine the distance between the motor vehicle and the NFC tag or the smartphone, or the NFC tag or the smartphone may be located inside the motor vehicle.

This method is in particular suitable for what is known as carsharing. So that various (other) people may now use the respective motor vehicle in this case, what is known as the smart access concept has been introduced. This involves the person who currently wishes to use the motor vehicle being provided with a virtual key. This virtual key may be transmitted to the mobile terminal of the user, for example. The user may thus open or unlock the motor vehicle using his mobile terminal.

The object of the present subject matter is to improve a convenience of use when controlling a motor vehicle by means of a vehicle-external mobile terminal and to avoid uncontrolled triggering of a function of the motor vehicle.

The object is achieved by the subjects of the independent patent claims. Advantageous developments of the present subject matter are disclosed by the dependent patent claims, the description that follows and the figures.

The present subject matter is based on the insight that the convenience of use when controlling the motor vehicle by means of the vehicle-external mobile terminal may be improved and the uncontrolled triggering of a function of the motor vehicle may be avoided if control commands for the motor vehicle are enabled depending on the distance or relative position of the mobile terminal in relation to the motor vehicle. The predetermined control commands for controlling the motor vehicle may be executed only at predetermined ranges and/or relative positions in relation to the motor vehicle.

This is accomplished by setting up a communication connection by means of a respective transmission/reception device of the motor vehicle and of the vehicle-external mobile terminal. In this context, vehicle-external or vehicle-extraneous means that the mobile terminal is separate from the motor vehicle. The mobile terminal is thus not a component or not a part of the motor vehicle. The mobile terminal may preferably be associated with a predetermined user. The user may use the mobile terminal to manually or automatically control the motor vehicle. To control the motor vehicle by means of the mobile terminal, a radio signal transmitted by means of the communication connection is subsequently evaluated in order to ascertain the distance and/or the relative position of the mobile terminal in relation to the motor vehicle. The distance and/or the relative position may be ascertained by the mobile terminal and/or by the motor vehicle. To this end, the motor vehicle and/or the mobile terminal may comprise an appropriate evaluation circuit. To simplify matters, the distance or the relative position of the mobile terminal in relation to the motor vehicle is also referred to as the range below. Exactly how the radio signal may be evaluated and how appropriate distance or position determination may then be carried out is described again more thoroughly later on. After the range has been ascertained, a control circuit of the motor vehicle or of the mobile terminal takes the ascertained distance and/or the ascertained relative position as a basis for generating clearance data. These clearance data indicate that at least one predetermined control command can be transmitted from the mobile terminal to the motor vehicle and/or is accepted from the mobile terminal by the motor vehicle. Finally, the at least one predetermined control command is transmitted from the mobile terminal to the motor vehicle by way of the communication connection. The respective predetermined control command is preferably transmitted by means of the aforementioned radio signal. However, the transmission is carried out only if the clearance data are available in the mobile terminal and additionally a predetermined trigger condition for the respective control command is satisfied. The trigger condition describes the circumstances under which or the way in which the control command is transmitted. The trigger condition is described again more thoroughly later on.

A control command or multiple control commands may thus be cleared for transmission to the motor vehicle on the basis of distance or on the basis of range. Different control commands are preferably approved for different ranges and can thus be transmitted or are accepted. Specific control commands are approved only in a predefined near area around the motor vehicle, while other control commands are approved from a greater range (far area), for example. Such areas may be defined by a person skilled in the art, for example. To put it another way, specific functions of the motor vehicle may be controlled only when there is a particular distance between the mobile terminal and the motor vehicle or within a predetermined area or field around the motor vehicle. The functions may include for example an unlock function or starting of the engine or adjustment of a driver's seat. The various control commands and functions are described again more thoroughly later on. It should be noted that the respective area is within a reception area that is available on the basis of radio. The meaning is not that the respective control command is blocked merely because there is no radio reception.

The range-dependent enabling and provision of the respective control command results in the advantage that a convenience of use may be improved. A user of the motor vehicle may therefore automatically adjust or manually adjust specific settings or functions, in particular user-related or individual settings, such as a seat position desired by the user or a desired radio station, before the user actually arrives at the motor vehicle, that is to say before a journey is started. Moreover, the advantage is also obtained that the uncontrolled triggering of the functions, that is to say the uncontrolled actuation of the motor vehicle, is avoided.

The aforementioned communication connection may be for example a WLAN connection, a Bluetooth connection, an NFC connection, a mobile radio connection, in particular a GSM connection (GSM: Global System for Mobile Communication) or a UWB connection (UWB: ultra-wideband). The aforementioned transmission/reception device may accordingly be in particular in the form of an antenna module by means of which the communication connection suitable for the respective communication standard may be made.

The present subject matter also comprises embodiments that result in additional advantages.

In the embodiments that follow, the range-dependent provision of the respective control command is now advantageously implemented first of all. According to one embodiment, one or more zones are defined for the ascertained distance and/or the ascertained relative position in an outside area around the motor vehicle. Each zone has an associated respective predetermined command class containing at least one particular control command. The aforementioned clearance data indicate which of the command classes is approved. In this context, approved means that the respective command class can be transmitted and/or is accepted.

To put it another way, at least one zone is thus defined in a defined area or radius around the motor vehicle, that is to say in the surroundings of the motor vehicle (outside area). For example, there may preferably be provision for two zones, that is to say for example a near zone and a far zone. By way of example, the far zone may describe an area for example up to 100 meters around the motor vehicle. Alternatively, the far zone may also be an area within a predetermined radius around the motor vehicle. A respective control command associated with the far zone may thus also be transmitted from a range of several hundred or thousand kilometers, for example. By contrast, the near zone may describe a boundary at a distance in a region of for example 15 meters, in particular 2 meters, around the motor vehicle. The near zone therefore encircles a smaller radius around the motor vehicle than the far zone.

The near zone may preferably comprise security-relevant control commands in its associated command class or near command class. In this context, security-relevant means in particular control commands that are advantageous for use under the supervision of the user or the operator of the motor vehicle. These may include the aforementioned control command for unlocking the motor vehicle, for example. By contrast, the far zone may comprise user-related or uncritical control commands in its respective command class or far command class, for example. User-related control commands mean in particular control commands for convenience settings. The user-related control commands may include control commands for adjusting the aforementioned seat system or the radio, for example. The near command class preferably also comprises the control commands of the far command class, however. All in all, this allows a range-dependent control command structure to be produced. As range increases, a security relevance of the control commands may fall.

The motor vehicle may thus be controlled on the basis of the zone that the user with the mobile terminal is currently in. This results in the advantage that theft prevention may be improved for the motor vehicle. Only if the user with the terminal is for example within a defined radius, for example within the near zone, is an unlock command cleared as a control command for opening the motor vehicle. The user is in the near zone in particular in sight of the motor vehicle, which means that it is more or less impossible for another person to use or steal the motor vehicle. Since user-related control commands may, by contrast, also be given clearance from a greater range than the aforementioned unlock command, however, it is moreover possible, as described above, to improve the user convenience and to increase the availability of the motor vehicle.

In regard to the range-dependent provision of the respective control command, a further embodiment provides for a zone to be defined for the ascertained distance and/or the ascertained relative position in an inside area of the motor vehicle. Inside area means in particular the interior enclosed by the motor vehicle, or the driver's cab. This zone or inside zone likewise has a specific associated command class containing at least one particular control command. The clearance data indicate that the respective command class is approved, that is to say can be transmitted and/or is accepted.

The zone or inside zone is formed by means of the interior or a volume encompassed by the driver's cab. The command class or interior command class associated with the inside zone may comprise in particular driving-relevant control commands as respective control command. These may include a control command to allow the engine to be started, for example. The term driving-relevant denotes control commands that are directly relevant or critical for the driving operation of the motor vehicle, for example. The interior command class may preferably also comprise the control commands for the near zone and the far zone, however.

The provision of the inside zone as a separate zone for controlling the motor vehicle results in the advantage that it is possible to ensure that the respective user is also actually in the motor vehicle before the respective control command is approved. This allows theft prevention to be improved further still.

The delimitation of the aforementioned zones from one another is advantageously produced in the embodiment that follows. According to one variant of this embodiment, the zones are delimited from one another by zone boundaries at different distances. The zone boundaries may preferably be virtual boundaries or boundary areas formed for example by a predetermined geometric shape, such as for example rings having a predetermined radius around the motor vehicle. The zone boundaries are at different distances from one another and therefore also at different distances from the motor vehicle, in particular from a center or focus of the motor vehicle. The aforementioned far zone may thus have a zone boundary with a first radius around the motor vehicle, for example, while the near zone has a zone boundary with a second radius around the motor vehicle. The first radius is greater than the second radius. The far zone may be encircled by the zone boundary of the near zone and the zone boundary of the far zone.

According to a second variant of this embodiment, the zones are delimited from one another by zone boundaries that describe a predetermined angular sector. The surroundings around the motor vehicle may be divided into specific angular sectors or circular sectors, for example. These circular sectors describe the division into the aforementioned zones. By way of example, there may thus be provision for control commands for different command classes for a frontal area or a lateral area or a rear area of the motor vehicle, each of which is described by the respective angular sector. Accordingly, the command classes available may be a frontal command class, a lateral command class and a rear command class, for example. The frontal command class preferably comprises control commands relating to frontally oriented components or function groups of the motor vehicle, such as for example a control command for controlling a front light system. The lateral command class preferably comprises control commands relating to laterally oriented components or function groups of the motor vehicle, such as for example a control command for controlling a window closing system for opening or closing the side windows. The rear command class preferably comprises control commands relating to rearwardly oriented components or function groups of the motor vehicle, such as for example a control command for controlling a rear light system.

All in all, each zone boundary may thus have a predetermined geometric shape that borders or encircles the respective zone. Only within the respective zone, that is to say when the respective zone boundary is crossed in the direction of the zone encircled thereby, is the particular associated control command approved.

Advantageous control commands for the respective command classes are now described more thoroughly in the embodiment that follows. According to this embodiment, the at least one control command that a first command class comprises is a control command for controlling a light system and/or an air conditioning system and/or a navigation device and/or a seat system and/or a multimedia interface of the motor vehicle. This first command class may be associated in particular with a zone in the outside area in relation to the motor vehicle, such as for example the far zone. This command class may therefore be used to adjust a light mode in the areas inside and outside the motor vehicle or an air conditioning setting, for example. Additionally or alternatively, driving routes or destinations may also be transmitted to the motor vehicle. It is also possible for a seat position adjustment to be made or it is possible for appointments, a calendar or a radio station to be provided to the motor vehicle by the mobile terminal. According to this embodiment, the at least one control command that a second command class comprises is a control command for controlling a closing system for at least one vehicle door and/or at least one vehicle window and/or a vehicle trunk and/or a vehicle roof. This second command class is thus likewise preferably associated with a zone in the outside area around the motor vehicle, preferably the aforementioned near zone. According to this embodiment, the at least one control command that a third command class comprises is a control command for controlling a starting system of the motor vehicle. An engine of the motor vehicle may be started or switched off. Additionally or alternatively, the control command may also be a control command for preventing closing of the respective closing system of the motor vehicle. It is thus possible for unlocking of the motor vehicle to be prevented while the mobile terminal, that is to say the vehicle key, so to speak, is still in the motor vehicle, for example. Additionally or alternatively, the control command may also be a control command for controlling a warning system of the motor vehicle. The user of the motor vehicle may thus be warned when the engine is switched off, for example, or advised to take the mobile terminal with him from the motor vehicle. The third command class is preferably associated with the aforementioned inside zone.

In order to be able to transmit the predetermined control command from the mobile terminal to the motor vehicle, the giving of clearance for the control command in the mobile terminal is described more thoroughly in the embodiment that follows. Accordingly, there is provision that if the clearance data are available then the at least one control command is enabled in the mobile terminal and is made available by way of an operator control element of the mobile terminal for selection. In this regard, the mobile terminal may comprise an appropriate application (app), for example, that may be used to control the motor vehicle. This application may initially store no control commands for selection, for example. However, if the mobile terminal is now in the communication connection to the motor vehicle and additionally still within the far zone, for example, all control commands associated with the far zone may be made visible and thus available to the user by means of the operator control element in the application. This may in particular also be carried out for the other zones analogously.

This results in the advantage that the user is thus provided with distinct feedback concerning which commands are currently active or enabled and which are not.

A preferred design of the aforementioned trigger condition is implemented in the embodiment that follows. Specifically, in one variant of the embodiment, under the terms of the trigger condition the transmission of the respective control command may be triggered automatically if the clearance data are available. As soon as the mobile terminal, in particular with the user, is within the respective zone, the particular associated control command is transmitted to the motor vehicle automatically, that is to say without the involvement of the user. Which of the control commands are transmitted automatically may preferably be associated in predetermined rules. The rules may be stored for example in a profile of the user in a storage device of the mobile terminal. According to a second variant of the embodiment, there is additionally or alternatively provision for the transmission of the respective control command to be triggered by a predetermined operator control action. The operator control action is preferably performed by the user of the mobile terminal. The respective operator control action may be a voice command, a gesture or a keystroke, for example. This allows the user himself to decide which control command he wishes to transmit to the motor vehicle within the zone.

The embodiments that follow relate to an advantageous implementation of the communication connection between the mobile terminal and the motor vehicle. According to one embodiment, the communication connection set up is a 5G communication connection for direct communication by the motor vehicle with the mobile terminal. The communication connection is made while bypassing any base stations. The respective transmission/reception device provided in the motor vehicle and the mobile terminal is accordingly likewise a 5G transmission/reception device. Such a transmission/reception device may be designed as a multichannel antenna module, for example.

The use of 5G technology to make the communication connection thus allows data, that is to say in particular the respective radio signal, to be interchanged between the mobile terminal and the motor vehicle at a higher data rate. Moreover, larger frequency ranges may also be used for data transmission, which means that in particular latencies during the data transmission may be reduced.

The embodiments that follow relate to the design of the motor vehicle to ascertain the distance between the motor vehicle and the mobile terminal. According to one variant of the embodiment, the motor vehicle comprises at least two transmission/reception devices to ascertain the distance and/or relative position. The transmission devices may also be referred to as telephone modules. Additionally or alternatively, according to a further variant of the embodiment, there is provision for the respective transmission/reception device to comprise a multi-antenna module. The transmission/reception device may preferably comprise multiple antennas in one telephone module or multiple telephone modules having one or more antennas in order to receive the radio signal from the mobile terminal. This results in the advantage that it allows the distance or the relative position to be ascertained redundantly, that is to say using multiple antennas simultaneously. The accuracy of the range determination may thus be improved.

According to a further embodiment, the distance and/or the relative position are ascertained by a time-of-flight measurement and/or a triangulation and/or a reception field strength measurement for the radio signal. The communication connection, in particular the transmission of the radio signal by way of the communication connection, may thus be used both as a communication data channel and for range measurement.

The embodiment that follows shows an advantageous implementation regarding how the communication connection between the mobile terminal and the motor vehicle may be set up. According to one variant of the embodiment, there is provision for at least one of the respective transmission/reception devices to set up the communication connection by executing a scanning mode to check respective surroundings for the presence of the other transmission/reception device. The surroundings are thus preferably scanned or checked under time control or constantly in the scanning mode. The transmission/reception device of the motor vehicle may transmit a request signal containing a request to make a communication connection in the scanning mode, for example at predefined intervals of time. Alternatively, the respective transmission/reception device may also wait for an applicable request signal to be received or to arrive, for example, in the scanning mode. This results in the advantage that the communication connection may thus be made particularly quickly and if possible without a time delay. This is because the respective transmission/reception device does not first need to be woken from a sleep mode or an idle mode, for example. The scanning mode is preferably of time-controlled design. The scanning mode may be activated in predefined time periods and deactivated in other time periods, for example.

In an additional or alternative variant of this embodiment, there is provision for the communication connection to be set up when the mobile terminal reaches a predefined or absolute position. The communication connection may be made on the basis of location, for example. This process is also referred to as geofencing. Accordingly, the communication connection is triggered automatically by the crossing of a virtual limit in the area around the motor vehicle. The limit may be determined by the aforementioned zones or zone boundaries, for example.

The present subject matter also relates to a system having a motor vehicle and a mobile terminal. The motor vehicle and the mobile terminal are configured to use a respective transmission/reception device to set up a communication connection. A respective evaluation circuit of the motor vehicle and/or of the mobile terminal is moreover configured to ascertain a distance and/or a relative position of the mobile terminal in relation to the motor vehicle by evaluating a radio signal transmitted by means of the communication connection. A control circuit of the motor vehicle and/or of the mobile terminal is configured to take the ascertained distance and/or the ascertained relative position as a basis for generating clearance data indicating that at least one predetermined control command can be transmitted from the mobile terminal to the motor vehicle and/or is accepted from the mobile terminal by the motor vehicle. Finally, the mobile terminal is configured to transmit the at least one predetermined control command to the motor vehicle by way of the communication connection if the clearance data are available in the mobile terminal and a predetermined trigger condition for the respective control command is satisfied.

The present subject matter also relates to a corresponding motor vehicle comprising at least one transmission/reception device for providing the communication connection to the mobile terminal. The motor vehicle moreover comprises an evaluation circuit configured to evaluate a radio signal transmitted by means of the communication connection and thereby to ascertain a distance and/or a relative position of the mobile terminal in relation to the motor vehicle. A control circuit of the motor vehicle is moreover configured to take the ascertained distance and/or the ascertained relative position as a basis for generating clearance data indicating that at least one predetermined control command can be transmitted from the mobile terminal to the motor vehicle and/or is accepted from the mobile terminal by the motor vehicle. Finally, the motor vehicle is configured to provide the clearance data to the mobile terminal by way of the communication connection and to receive or capture the predetermined control command after providing the clearance data.

The motor vehicle is preferably designed as a motor car, in particular as an automobile or a truck, or as a passenger bus or motorcycle.

Finally, the present subject matter relates to a mobile terminal for a system as described above. The mobile terminal comprises at least one transmission/reception device for providing the communication connection to the motor vehicle. Moreover, the mobile terminal comprises an evaluation circuit configured to evaluate a radio signal transmitted by means of the communication connection and thereby to ascertain a distance and/or a relative position of the mobile terminal in relation to the motor vehicle. A control circuit of the motor vehicle is furthermore configured to take the ascertained distance and/or the ascertained relative position as a basis for generating clearance data indicating that at least one predetermined control command can be transmitted from the mobile terminal to the motor vehicle and/or is accepted from the mobile terminal by the motor vehicle. Alternatively, however, the transmission/reception device may also be configured to receive the clearance data from the mobile terminal. If the clearance data are available in the mobile terminal, the control circuit is configured to generate the predetermined control command and to provide it to the motor vehicle by way of the communication connection.

The present subject matter also includes developments of the system according to the present subject matter and the motor vehicle according to the present subject matter and the mobile terminal according to the present subject matter that comprise features that have already been described in connection with the developments of the method according to the present subject matter. For this reason, the corresponding developments of the system according to the present subject matter, the motor vehicle according to the present subject matter and the mobile terminal according to the present subject matter are not described again here.

Further features of the present subject matter will emerge from the claims, the figures and the description of the figures. The features and combinations of features that are cited in the description above and the features and combinations of features that are cited in the description of the figures below and/or shown in the figures alone may be used not only in the particular indicated combination but also in other combinations or on their own.

The present subject matter is now explained more thoroughly on the basis of a preferred example embodiment and with reference to the drawings, in which:

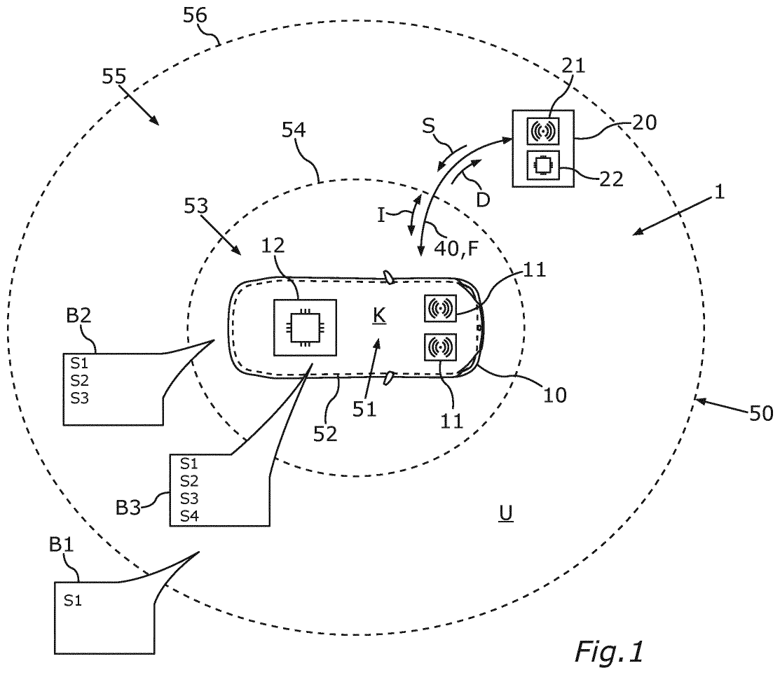

FIG. 1 shows a schematic perspective view of a system containing a motor vehicle and a mobile terminal that is configured to control the motor vehicle on the basis of range; and

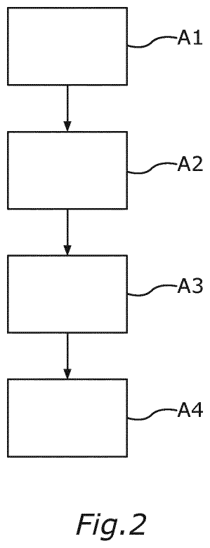

FIG. 2 shows a schematic representation of an illustrative sequence for a method for controlling the motor vehicle with the mobile terminal.

FIG. 1 shows a plan view of a system 1 containing a motor vehicle 10 and a mobile terminal 20. The system 1 is intended to be used in such a way that the mobile terminal 20 is used to control the motor vehicle 10 or in particular a function of the motor vehicle 10. The control may include not only the transmission of user settings, such as for example a position of a driver's seat, but also the adjustment of security-relevant or driving-relevant functions of the motor vehicle. The driving-relevant functions may include in particular switching an engine of the motor vehicle 10 on or off. The security-relevant relevant functions may include in particular controlling a closing system of the motor vehicle 10 in order to unlock or lock a vehicle door or a vehicle window.

For the purpose of controlling or remotely controlling the motor vehicle 10, the mobile terminal 20 comprises a transmission/reception device 21, such as for example an antenna module. Accordingly, the motor vehicle 10 also comprises, as shown in FIG. 1, two corresponding transmission/reception devices 11, which may likewise be designed as a respective antenna module, for example. By means of these transmission/reception devices 11, 21, the motor vehicle 10 and the mobile terminal 20 are designed to set up a communication connection 40 to one another. This communication connection 40 may now be used by the motor vehicle 10 and the mobile terminal 20 to transmit radio signals F and thus for example information data I to one another. The communication connection 40 may be a WLAN connection, a Bluetooth connection or a mobile radio connection, for example. The communication connection may preferably be designed as a 5G communication connection based on the 5G mobile radio standard, however. Accordingly, the transmission/reception devices 11, 21 may also likewise be designed as 5G-compatible antenna modules, that is to say in particular as multichannel antenna modules. This design of the communication connection 40 results in the advantage that a smartphone-compatible technology, namely 5G technology, is used, which is normally widely available. The field of application may thus be extended to control the motor vehicle 10 by means of the mobile terminal 20. Moreover, an increased bandwidth of information data I may thus also be transmitted between the motor vehicle 10 and the mobile terminal.

However, to now be able to provide theft prevention and at the same time the highest possible level of user convenience when using the system 1, for example, the motor vehicle 10 is controlled in particular on the basis of range. The motor vehicle 10 may be controlled on the basis of a distance and/or a relative position of the mobile terminal 20 in relation to the motor vehicle 10. To this end, the motor vehicle may preferably evaluate a radio signal F transmitted by means of the communication connection, so as to obtain the distance and/or the relative position, also referred to as range below. The radio signal may be a request signal from the motor vehicle 10 to the mobile terminal 20, for example, which is needed in order to make the communication connection. Alternatively, the radio signal to be evaluated may also be a response signal from the mobile terminal 20 in response to the request signal to make the communication connection 40. Exactly how the evaluation may take place is explained again more thoroughly later on.

Depending on the ascertained range, the motor vehicle 10 may then generate clearance data D. These clearance data D indicate that at least one predetermined control command can be transmitted from the mobile terminal 20 to the motor vehicle 10, or is accepted from the mobile terminal 20 by the motor vehicle 10. These clearance data D may then be transmitted to the mobile terminal 20 by means of the communication connection 40. To generate and provide the clearance data D and to evaluate the radio signal F for the purpose of determining the range, the motor vehicle 10 preferably comprises a control circuit 12. The control circuit 12 may in particular be designed as a computing unit or computing device and/or as a CPU (central processing unit) or ECU (electronic control unit) of the motor vehicle 10. To evaluate the radio signal F, the control circuit 12 may preferably comprise an evaluation module or evaluation circuit, which is not shown in FIG. 1. As soon as the clearance data D are now available in the mobile terminal 20, that is to say have been received by the mobile terminal 20, a control command S or multiple control commands S is or are given clearance in the mobile terminal 20 for selection. The respective control command S may then be made available by way of an operator control element of the mobile terminal 20 for selection. A command list containing control commands associated with the particular distance and/or relative position of the mobile terminal 20 in relation to the motor vehicle 10 may thus preferably be displayed to a user of the mobile terminal 20. When the user and thus the mobile terminal 20 approaches or moves away from the motor vehicle 10, this command list may be updated as appropriate.

The respective control command S may be transmitted from the mobile terminal 20 to the motor vehicle 10 by way of the communication connection 40 according to a predetermined trigger condition in order to control the motor vehicle 10. The trigger condition may describe when or how the respective control command S is transmitted. For example, the transmission may be triggered automatically when the clearance data D are available. Additionally or alternatively, there may also be provision for a predetermined operator control action by a user of the mobile terminal 20 in order for the respective control command S to be transmitted. The operator control action may comprise either a voice command or a gesture or a keystroke. To generate and transmit the control command S, the mobile terminal 20 likewise comprises a control circuit 22. The control circuit 22, like the control circuit 12, may preferably likewise be designed as a computing unit or computing device, in particular as a CPU or ECU.

The distance and/or the relative position of the mobile terminal 20 in relation to the motor vehicle 10 may preferably be determined by means of time-of-flight measurement for the transmitted radio signal F. Additionally or alternatively, the range may also be provided by way of a triangulation. To this end, at least one of the transmission/reception devices 11 of the motor vehicle 10 may preferably be designed as a multi-antenna module, for example as a 5G antenna module. Alternatively, it would also be possible for the range to be determined or for the range to be ascertained by way of a field strength measurement for the radio signal too.

As FIG. 1 shows, range-dependent control of the motor vehicle 10 using the respective control command S is accomplished by splitting surroundings around the motor vehicle 10, that is to say an outside area U in relation to the motor vehicle 10, into two zones 50. A further zone 50 is provided by the inside area K of the motor vehicle 10. There is therefore provision for three zones 50 according to FIG. 1. Each of the zones 50 has an associated respectively predetermined command class B1, B2, B3 containing at least one particular control command S1 to S4. The zones 50 are designed as an interior zone 51, a near zone 53 and a far zone 55 in FIG. 1. The interior zone 51 is preferably enclosed by a space or a volume that is bounded by the driver's cab of the motor vehicle 10. The vehicle housing or vehicle chassis is thus a virtual or imaginary zone boundary 52 for the interior zone 51. This zone boundary 52 thus separates the interior zone 51 from the rest of the zones 50. The near zone 53 is outside the motor vehicle 10, that is to say in the outside area U. The near zone 53 likewise comprises a zone boundary 54, which delimits the near zone 53 from the far zone 55 and the remainder of the outside area U. The zone boundary 54 describes a ring having a predefined radius around the motor vehicle 10. The aforementioned far zone 55 is also in the outside area U. The far zone 55 also comprises a zone boundary 56, which delimits the far zone 55 from the remainder of the outside area U. The zone boundary 56 likewise describes a ring having a predetermined radius around the motor vehicle 10. The radius of the zone boundary 56 is greater than the radius of the zone boundary 54. The near zone 53 is thus inside the zone boundary 56 of the far zone 55. Accordingly, the interior zone 51 is also inside the zone boundary 54 of the near zone 53 and the zone boundary 56 of the far zone 55. As an alternative to the design of the zone boundaries that is shown in FIG. 1, any other geometric shape is naturally also possible for the respective zone boundary 52, 54, 56.

For each of these zones 50, there is now provision, as described above, for various command classes containing different control commands S1 to S4. A first command class B1 may be associated with the far zone 55, for example. As shown by way of example in FIG. 1, the first command class B1 may comprise just one control command S1. The control command S1 may be a user-related or uncritical control command S, for example. The control command S1 may thus be used to adjust a convenience setting or a convenience function of the motor vehicle 10, for example. For example, the control command S1 may be a command for controlling a light system and/or an air conditioning system and/or a navigation device and/or a seat system and/or a multimedia interface of the motor vehicle 10.

The second command class B2 may be associated with the near zone 53, for example. As FIG. 1 shows, the second command class B2 may comprise not only the control command S1 described above but additionally also the control commands S2 and S3. The control commands S1 to S3 may preferably be security-relevant control commands. In this context, security-relevant means in particular that they are control commands for controlling a security function of the motor vehicle 10. The control commands S2 and S3 may be for example control commands for controlling a closing system for at least one vehicle door and/or at least one vehicle window and/or at least one vehicle trunk and/or at least one vehicle roof of the motor vehicle 10. The control commands S2 and S3 thus relate in particular to the opening or closing of the motor vehicle 10.

Finally, the third command class B3 is associated with the interior zone 51. Besides the control commands S1 to S3 described above, the third command class B3 additionally comprises the control command S4 too. The control command S4 may be in particular a driving-relevant control command. The control command S4 may be used in particular to control a function of the motor vehicle 10 that is relevant to driving operation. For example, the control command S4 may be used to control a starting system of the motor vehicle and/or to prevent closing of the respective closing system of the motor vehicle 10 and/or to control a warning system of the motor vehicle.

Depending on which zone 50 the mobile terminal 20 is currently in, different functions or settings may thus be encountered for the motor vehicle 10. Since the user-related control commands have now been given clearance within the far zone 55, for example, and may be transmitted, user-related settings, such as for example a seat position, may be adjusted even before the user arrives at the motor vehicle 10, for example. As a result of the security-relevant control commands being given clearance only within the near zone 53, it is possible to prevent another person from using the motor vehicle, for example. By giving clearance for the driving-relevant control command S4 within the interior zone 51, it is thus possible to ensure that the applicable user with the mobile terminal 20 is also in the motor vehicle 10.

In order now to check which of the control commands S1-S4 are currently supposed to be enabled, the distance between the motor vehicle 10 and the mobile terminal 20 is ascertained, as described above. This makes it possible to establish which of the zones 50 the mobile terminal 20 with the user is currently in. To this end, the control circuit 12 may be used to determine a distance value between the motor vehicle 10 and the mobile terminal 20, for example. The distance value may subsequently be compared with a range value range. This range value range is in particular defined by the zone dimensions, that is to say preferably by the respective zone boundaries 52, 54, 56. By way of example, the evaluation module of the control circuit 12 may thus be used to check whether the distance value is less than a radius of the respective zone boundary 52, 54, 56. If the distance value is less than the radius of the respective zone boundary 52, 54, 56, it is thus possible to confirm that the mobile terminal 20 is present in the respective zone 50. The aforementioned clearance data D may thus be generated and therefore the respective control commands S, S1-S4 enabled according to the zone 50.

The example embodiment shown in FIG. 1 could now be based on the following situation by way of illustration: a user of a 5G-compatible mobile radio, that is to say for example the mobile terminal 20, moves toward a motor vehicle 10 having one or two telephone modems (transmission/reception device 11) that has previously been selected by him. Either absolute positions or a scan mode are/is used to set up a connection (communication connection 40) between the mobile radio and the motor vehicle 10. The communication connection 40 is used to determine the relative position of the user and in particular of the mobile terminal 20 in relation to the motor vehicle 10. Following confirmation and authorization, the motor vehicle 10 accepts uncritical data and commands from the mobile radio. The commands (control commands S1, S2, S3, S4) are accepted within a defined radius around the motor vehicle 10. Some commands, such as for example opening or closing a vehicle roof, require the user to be close by so that the triggered function, that is to say the opening of the roof, may be monitored. Other commands absolutely require a presence in the motor vehicle 10, on the other hand. These commands include clearance for starting the engine, for example.

FIG. 2 again shows method steps for performing a method for controlling the motor vehicle 10 by means of the mobile terminal 20 by way of illustration. The method steps are arranged in a method flow diagram in FIG. 2. According to a step A1, a respective transmission/reception device 11, 21 of the motor vehicle 10 and of the mobile terminal 20 is first of all used to set up the communication connection 40. In a step A2, the distance and/or the relative position of the mobile terminal 20 in relation to the motor vehicle 10 is then ascertained by evaluating the radio signal F transmitted by means of the communication connection 40. Next, in a step A3, the control circuit 12 of the motor vehicle 10 takes the ascertained distance and/or the ascertained relative position as a basis for generating the clearance data D. Alternatively, the clearance data may also be generated by means of the control circuit 22, however. As described above, the clearance data indicate that the at least one predetermined control command S, S1 to S4 can be transmitted from the mobile terminal 20 to the motor vehicle 10 by way of the communication connection 40, or the motor vehicle 10 accepts the respective control command S, S1 to S4 from the mobile terminal 20. Finally, in a step A4, the predetermined control command S, S1 to S4 is transmitted from the mobile terminal 20 to the motor vehicle if the clearance data D are available in the mobile terminal 20 and the predetermined trigger condition for the respective control commands S, S1 to S4 is satisfied.

All in all, the examples thus show how a motor vehicle 10 may be controlled by means of a 5G-compatible mobile radio.

List of reference signs

| | |
|---|---|
| 1 | system |
| 10 | motor vehicle |
| 11 | transmission/reception device |
| 12 | control circuit |
| 20 | mobile terminal |
| 21 | transmission/reception device |
| 22 | control circuit |
| 40 | communication connection |
| 50 | zone |
| 51 | interior zone |
| 52 | zone boundary |
| 53 | near zone |
| 54 | zone boundary |
| 55 | far zone |
| 56 | zone boundary |
| A1 | first step |
| A2 | second step |
| A3 | third step |
| A4 | fourth step |
| B1 | first command class |
| B2 | second command class |
| B3 | third command class |
| D | clearance data |
| F | radio signal |
| I | information data |
| K | inside area |
| S | control command |
| S1 | control command |
| S2 | control command |
| S3 | control command |
| S4 | control command |
| U | outside area |

1.-14. (canceled)

15. A method for controlling a motor vehicle using a vehicle-external mobile terminal, comprising:
establishing a communication connection using a first transmission/reception device of the motor vehicle and second transmission/reception device of the mobile terminal;
ascertaining a distance and/or a relative position of the mobile terminal in relation to the motor vehicle by evaluating a radio signal transmitted via the communication connection;
generating clearance data using a control circuit of the motor vehicle or of the mobile terminal based on the ascertained distance and/or the ascertained relative position, wherein
the clearance data indicates that a predetermined control command can be transmitted from the mobile terminal to the motor vehicle and/or is accepted from the mobile terminal by the motor vehicle; and
transmitting the predetermined control command from the mobile terminal to the motor vehicle using the communication connection when the clearance data are available in the mobile terminal and a predetermined trigger condition for the respective control command is satisfied.

16. The method according to claim 15, wherein
one or more zones are defined for the ascertained distance and/or the ascertained relative position in an outside area around the motor vehicle,
each zone has an associated respective predetermined command class containing a control command, and
the clearance data indicates which command class is approved.

17. The method according to claim 15, wherein
a zone that has an associated predetermined command class containing a control command is defined for the ascertained distance and/or the ascertained relative position in an inside area of the motor vehicle, and
the clearance data indicates that the command class is approved.

18. The method according to claim 16, wherein
the zones are delimited from one another by zone boundaries at different distances, and/or
the zones are delimited from one another by zone boundaries that describe a predetermined angular sector.

19. The method according to claim 16, wherein
the control command that a first command class comprises is configured to control a light system and/or an air conditioning system and/or a navigation device and/or a seat system and/or a multimedia interface of the motor vehicle,
the control command that a second command class comprises is configured to control a closing system for:
a vehicle door, a vehicle window, a vehicle trunk, and/or a vehicle roof, and
the control command that a third command class comprises is configured to control a starting system of the motor vehicle and/or for preventing closing of the respective closing system of the motor vehicle and/or for controlling a warning system of the motor vehicle.

20. The method according to claim 15, wherein
if the clearance data is available then the control command is enabled in the mobile terminal, and
the control command is made available via an operator control element of the mobile terminal for selection.

21. The method according to claim 15, wherein
under the terms of the trigger condition the transmission of the respective control command is triggered automatically if:
the clearance data are available, and/or
the transmission of the respective control command is triggered by a predetermined operator control action.

22. The method according to claim 15, wherein
the communication connection set up is a 5G communication connection for direct communication between the motor vehicle and the mobile terminal, and
the first and second transmission/reception devices are 5G transmission/reception devices.

23. The method according to claim 15, wherein
the first transmission/reception device of the motor vehicle further comprises two transmission/reception devices to ascertain the distance and/or the relative position, and/or
one or more of the transmission/reception devices of the motor vehicle comprises a multi-antenna module.

24. The method according to claim 15, wherein
the distance and/or the relative position are ascertained by a time-of-flight measurement and/or a triangulation and/or a reception field strength measurement for the radio signal.

25. The method according to claim 15, wherein the step of establishing the communication connection further comprises:
executing a scanning mode to check respective surroundings for the other of the first or second transmission/reception device.

26. The method according to claim 15, wherein
the communication connection is established when the mobile terminal reaches a predefined position.

27. A system, comprising:
a motor vehicle, comprising:
a first transmission/reception device configured to establish a communication connection; and
a mobile terminal, comprising:
a second transmission/reception device configured to:
establish the communication connection, and
transmit a predetermined control command to the motor vehicle via the communication connection if clearance data are available in the mobile terminal and a predetermined trigger condition for the control command is satisfied,
wherein
an evaluation circuit of the motor vehicle and/or of the mobile terminal is configured to ascertain a distance and/or a relative position of the mobile terminal in relation to the motor vehicle by evaluating a radio signal transmitted using the communication connection,
a control circuit of the motor vehicle or of the mobile terminal is configured to take the ascertained distance and/or the ascertained relative position to generate the clearance data that indicates the predetermined control command can be transmitted from the mobile terminal to the motor vehicle and/or is accepted from the mobile terminal by the motor vehicle.

28. A motor vehicle, comprising
a transmission/reception device configured to provide a communication connection to a mobile terminal;
an evaluation circuit configured to evaluate a radio signal transmitted using the communication connection to ascertain a distance and/or a relative position of the mobile terminal in relation to the motor vehicle; and
a control circuit configured to take the ascertained distance and/or the ascertained relative position to generate clearance data indicating that a predetermined control command can be transmitted from the mobile terminal to the motor vehicle and/or is accepted from the mobile terminal by the motor vehicle, wherein
the clearance data is provided to the mobile terminal via the communication connection, and
the predetermined control command is received via the communication connection after providing the clearance data.
